(19) United States
(12) Patent Application Publication
(10) Pub. No.: US 2008/0001741 A1
(43) Pub. Date: Jan. 3, 2008

(54) Large area distributed sensor

(75) Inventors: Cornel P. Cobianu, Bucharest (RO); Ion Georgescu, Bucharest (RO); Viorel-Georgel Dumitru, Ploiesti (RO)

Correspondence Address: Kris Fredrick. Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/477,257

(22) Filed: Jun. 29, 2006

(51) Int. Cl. G08B 13/14; G08B 21/00

(52) U.S. Cl. 340/568.2; 340/652

(57) ABSTRACT

A wireless monitoring system and method. A distributed electrical circuit can be printed on a dielectric film for wrapping pallets or containers in a logistic chain, wherein the distributed electrical circuit (e.g., a Wheatstone Bridge) detects a rupture of the film through an electrical resistance change of one or more elements of the distributed electrical circuit. The electrical resistance change is indicative of a potential tampering event. An electronic module can be provided that conditions and processes a signal transmitted from the distributed electrical circuit and thereafter transmits the signal wirelessly via an antenna to a monitoring station. Additionally, a monitoring station can be implemented, which communicates with a network and the electronic module, and permits a user in real time to receive data concerning the potential tampering event.

### TECHNICAL FIELD

Embodiments are generally related to tampering event detection methods and systems. Embodiments are also related to large area distributed sensors.

### BACKGROUND

Damage of goods in transportation is a major problem in the field of logistics. When a shipment is received in a damaged condition, there are usually no possibilities to track when the damage occurred, which turns the question of liability into an open question.

Further, intrusion and tamper events, such as illegal opening and/or modification of the content of the shipment are major concerns when handling valuable or sensitive goods. Theft, where valuable items are removed and stolen from the shipment is one aspect and another is illegal modification of a shipment's content. If a receiver claims that a shipment was not received in an expected condition, the sender cannot resolve if the receiver fraudulently claims that a theft or damage is due to an event in the logistics chain.

Rising concerns about possible hazardous contents of alien shipments, where contents may include explosives, poison, biological agents etc. poses a major threat for organizations and employees at time of arrival.

Traditional means of ensuring the integrity and authenticity of a shipment include different types of sealing, where a tamper event can be visually detected at time of arrival. Holograms, lacquer sealing, security printing and other traditional methods of ensuring an item's authenticity is generally not strong enough to withstand today's sophisticated methods of counterfeiting and fraud.

Automation of logistics typically includes machine readable labels, such as bar codes, data matrix codes, RFID-tags etc., where information concerning the shipment can be read and processed by a host computer system. Current solutions generally provide little or no means of active authentication of the label itself. Any attempt to illegally copy, modify or move the label should be detected as an integrity violation.

It is believed that given the problems with current solutions, the ability to wirelessly monitor the integrity of wrapped pallets or containers in a logistics chain is highly desirable. Unfortunately, traditional solutions are not wireless in nature, and typically rely on off-line recording of a package violation event utilizing sensors and electronic modules composed of microprocessors and semiconductor memories. It is only at the destination of the package where the tampering event is detectable, based on a communication protocol between a receiver computer and an electronic module integrated in the package sent by an expeditor. Most often, this rather late identification of a package rupture, after the package has arrived at its destination, makes it difficult to determine retroactively the source of the tampering.

Additionally, large area monitoring is difficult to achieve with present technical solutions based on printed electrical resistance and its change monitoring as a function package tearing, where the maximum sensing resistance appears to be less than 500 kohm. It is our solution that will allow large area of monitoring and real time warning of both the sender and the receiver about the tampering event of the package of interest for both of them.

In summary, it would be desirable to be able to verify the integrity and authenticity of the shipment at any time during transportation and in real time before arrival to the receiver in an automated, highly secure and dependable manner.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for improved system and method for monitoring a tampering event.

It is yet another aspect of the present invention to provide for a large area distributed sensor.

The aforementioned aspects of the invention and other objectives and advantages can now be achieved as described herein. A wireless monitoring system and method is disclosed. A large area distributed electrical circuit can be printed on a dielectric film for wrapping pallets or containers in a logistic chain, wherein the distributed electrical circuit detects a rupture of the film through an electrical resistance change of one or more elements of the distributed electrical circuit. The electrical resistance change is indicative of a potential tampering event. An electronic module can be provided that conditions and processes a signal transmitted from the distributed electrical circuit and thereafter transmits the signal wirelessly via an antenna to a monitoring station. Additionally, a monitoring station can be implemented, which communicates with a network and the electronic module, and permits a user in real time to receive data concerning the potential tampering event associated the pallets or containers based on the electrical resistance change of the element(s) of the large area distributed electrically circuit, thereby permitting wireless monitoring of the integrity of the film and the pallets or containers in the logistic chain.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIGS. 1(a), 1(b), and 1(c) illustrate schematic diagrams of respective large area conductive traces printed on a dielectric substrate in accordance with or more varying embodiments;

FIG. 2 illustrates a schematic diagram of a large area distributed sensing system, which can be implemented in accordance with a preferred embodiment;

FIG. 3 illustrates a schematic diagram of an array of sensing systems composed of a plurality of sensors, each of which communicates wirelessly with a single unit for system monitoring and transmission, whose signal is then sent wirelessly to a central monitoring station, in accordance with a preferred embodiment; and

FIG. 4 illustrates a schematic diagram of an ultra large array of sensing systems composed of a plurality of arrays of sensing systems, in accordance with a preferred embodiment.

### DETAILED DESCRIPTION

The particular values and configurations discussed in these non-limiting examples can be varied and are cited merely to illustrate at least one embodiment and are not intended to limit the scope of the invention.

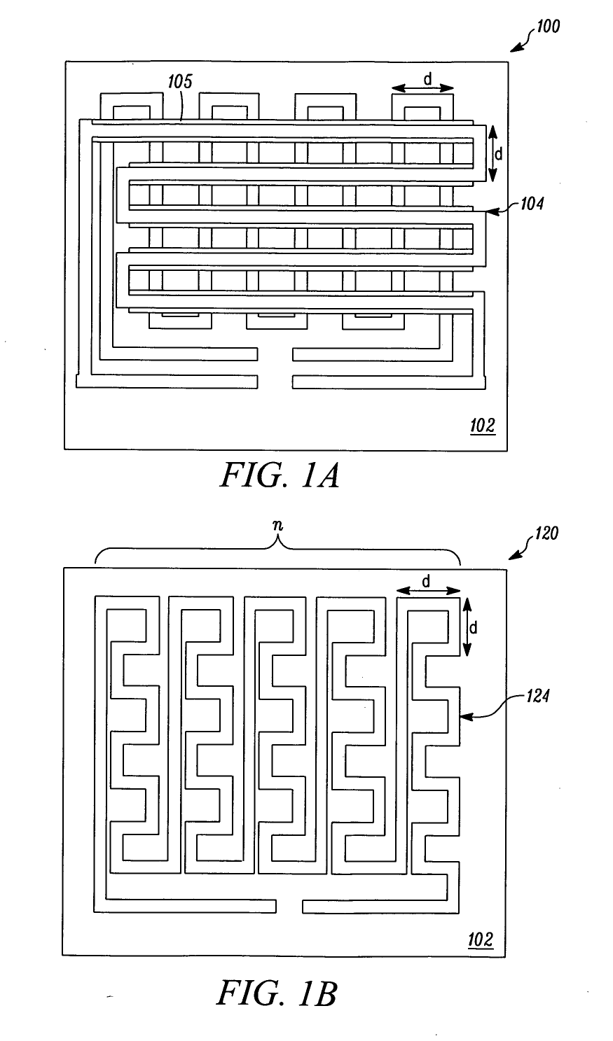

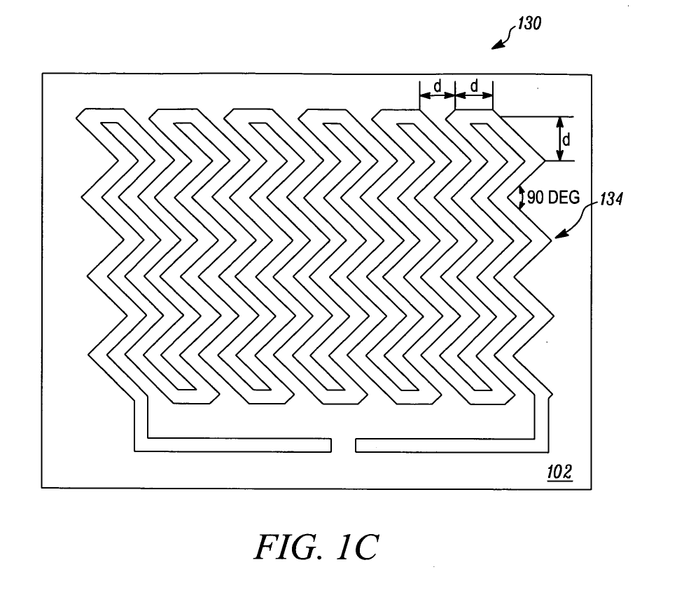

FIGS. 1(a), 1(b), and 1(c) illustrate schematic diagrams of respective sensing dielectric substrate systems 100, 120, and 130, which can be implemented in accordance with varying embodiments. System 100 generally includes a dielectric film 102 upon which a printed electrically conductive trace 104 can be configured. Note that in FIGS. 1(a), 1(b), and 1(c), identical or similar parts or elements are indicated generally by identical reference numerals. In FIG. 1(a), a dielectric layer 105 can be deposited between two conductive traces for electrical isolation between two conducting traces 104. System 120 depicted in FIG. 1(b) includes the same dielectric substrate 102 depicted in FIG. 1(a), but with a different large area printed electrically conductive trace 124 pattern. System 130 depicted in FIG. 1(c) includes the dielectric substrate 102 and a different printed electrically conductive trace 134.

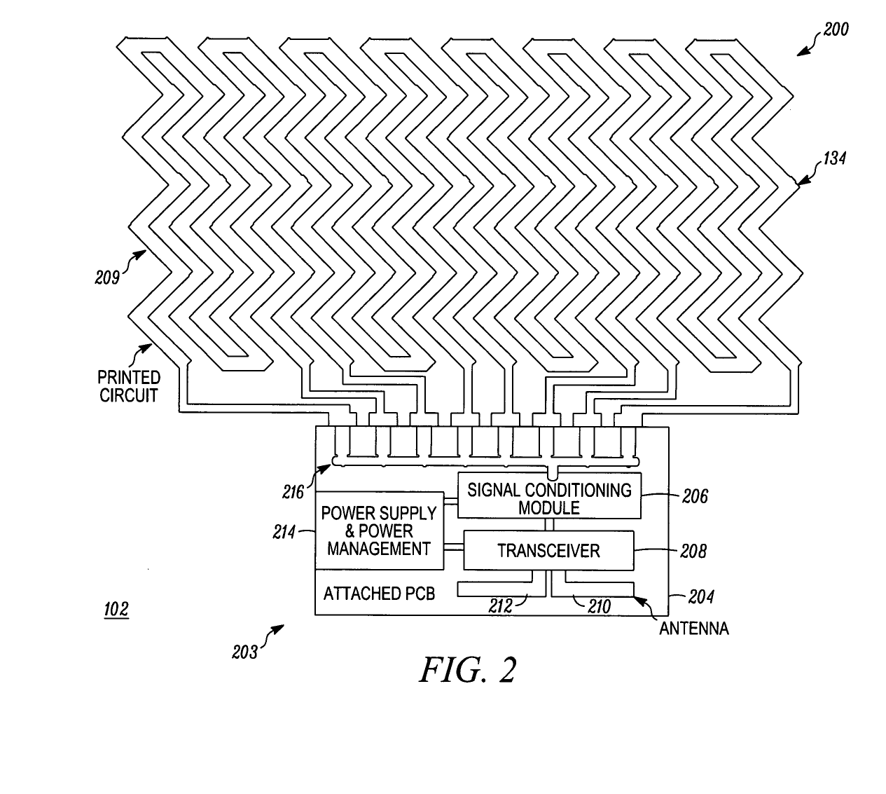

FIG. 2 illustrates a schematic diagram of a mechanical integrity wireless sensing system 200, which can be implemented in accordance with a preferred embodiment. Again, note that in FIGS. 1(a), 1(b), 1(c) and FIGS. 2-3 and 4, identical or similar parts or elements are generally indicated by identical reference numerals. The configuration of sensing systems 200 is based on the configuration depicted in FIG. 1(c). The sensing system 200 generally includes the large area distributed conductive trace 134, which forms a distributed integrity sensing electrical circuit 209 that is electrically connected by the pads 216 to an electronic module 203, which includes a transceiver 208 connected to a signal conditioning circuit 206. Both the transceiver 208 and the signal condition circuit 206 are connected to a power module 214 that functions as a combined power supply and power management unit. The transceiver 208 can be connected to an antenna 210, 212 that can wirelessly transmit data. The power module 214, the signal conditioning circuit 206, and the transceiver 208 are attached to a Printed Circuit Board (PCB) 204 and together form the electronic module 203.

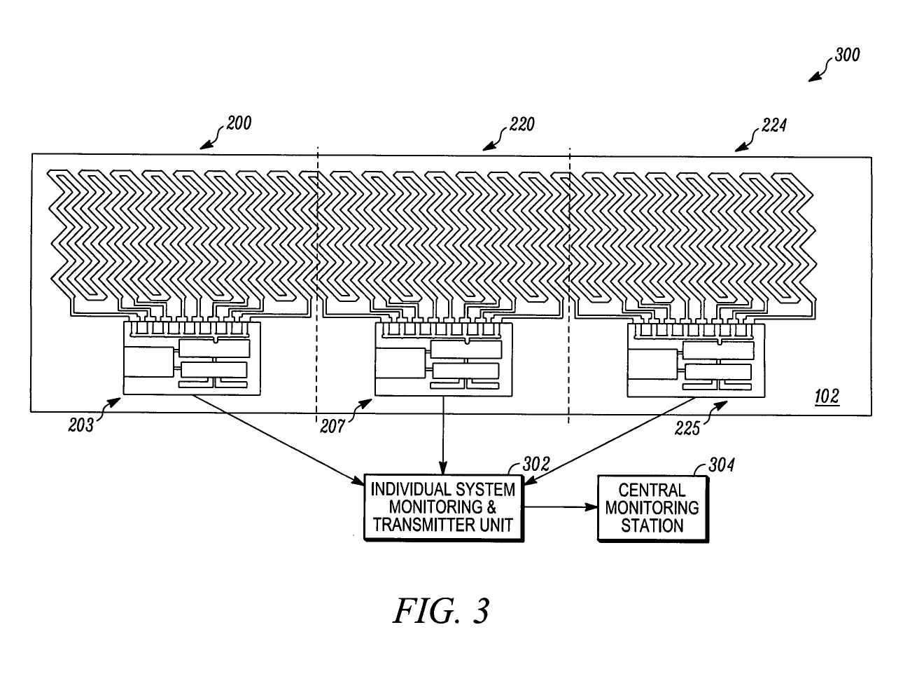

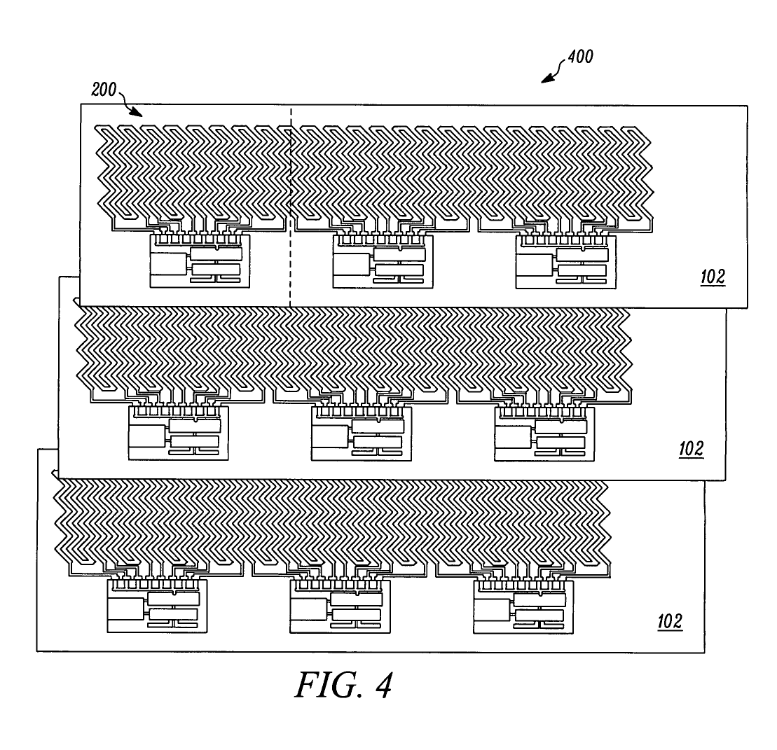

FIG. 3 illustrates a schematic diagram of an array 300 composed of a plurality of sensing systems 200, 220, 224, a unit 302 for system monitoring and transmission, and a central monitoring station 304, in accordance with a preferred embodiment. Note that the sensing systems 220 and 224 are analogous to sensing system 200, and include the same basic type of components as sensing system 200. For example, sensing system 200 includes electronic modules 203, while systems 220 and 224 respectively contain electronic modules 207 and 225, which are each identical to electronic module 203. Thus, systems 220 and 224 are identical to system 200. Systems 200, 220 and 224 can each respectively wirelessly communicate with the unit 302, which in turn is connected to the central monitoring station 304.

FIG. 4 illustrates a schematic diagram of an ultra large array 400 composed of a plurality of sensors, such as sensing system 200, in accordance with a preferred embodiment. The configuration depicted in FIG. 4 serves to illustrate how a variety of similar components or sensing system 200 can be utilized to form a distributed monitoring system, and each such sensing system comprising a large area distributed sensing circuit.

In general, for monitoring the integrity of the dielectric film 102 wrapped about a pallet or container, the printed large area distributed electrical circuit 209 and the electronic module (not shown in FIGS. 1(a), 1(b) and 1(c)) 203 can be utilized. Such a distributed circuit 209 can be utilized to detect a rupture of the dielectric film 102 through an electrical resistance change of one or more elements of the circuit 209. The electronic module 203 can condition and process one or more signals output from the distributed circuit 209 and then transmit the processed and conditioned signal wirelessly through the antenna 212, 210 to a monitoring station. This monitoring station can be connected to a networked service (e.g., computer network), such as the Internet, for real time warnings at both the sender and receiver portions of a logistic chain. The electronic module 203 and the antenna 210, 212 can be attached to or on the dielectric film 102 in a manner that ensures a good electrical connection with the printed electrical circuit (e.g., electrically conductive traces 104, 124 and/or 134) 209.

Such a configuration can be realized utilizing a “flip-chip” approach and a low temperature curing electrically conductive epoxy paste. Alternatively, the antenna can be directly printed on the dielectric film 102. The electrical circuit 209 generally comprises printed electrical conductive traces such as, for example, conductive traces 104, 124 and/or 134. Such printed electrically conductive traces 104, 124 and/or 134 can be printed on dielectric film 102. The film 102 can be used as a pallet wrapping either before or after the wrapping process. For this purpose, an electrically conductive ink can be printed by screen-printing, flexography, ink-jet or other printing technologies. In case the printed electrically conductive traces are realized after wrapping, ink-jet printing technology is preferably used. When the conductive traces 104,124 and/or 134 are printed before the wrapping process, large area printing technologies such as screen printing or flexography are preferably utilized.

Various conductive inks such as, for example, metallic nanoparticle based inks, inherently conductive polymers and/or metal-filled polymer based inks, can be adapted for use in printing the electrically conductive traces 104, 124 and/or 134. Such printed electrically conductive traces 104, 124 and/or 134 can be implemented in accordance varying configurations, some examples of which are shown in FIGS. 1(a), 1(b), and 1(c). In the configuration depicted in FIG. 1(a), the electrically conductive trace 104 can be disposed in two layers separated by an isolator. The two layers can be also printed on one of the different foils from which the wrapping film 102 is composed. Such layers can be printed on each side of the same dielectric foil. In this manner, an electrically conductive network can be obtained, which realizes the monitoring of dielectric film integrity with a high accuracy.

In the case of printing a conductive ink on both sides of a dielectric material, vias-type electrical contacts can be utilized to configure an electrical connection between an upper side and a lower side (not shown in FIG. 1(a)). The configurations depicted in FIGS. 1(a), 1(b), and 1(c) generally include a single layer of electrically conductive traces, which have the advantage of an easier and less expensive implementation. While not as accurate for detecting ruptures as the configuration of FIG. 1(a), the configurations of FIGS. 1(b) and 1(c) nevertheless detect with high probability a tentative theft or an involuntary rupture of the wrapping dielectric film 102, taking into account the fact that such a rupture tends to propagate far away from its initial point on the surface of the film 102.

In any of configurations of distributed conductive traces 100, 120, and/or 130, the pattern dimensions of respective electrically conductive traces 104, 124 and/or 134 can be selected as a function of the desired spatial resolution for monitoring the area of the dielectric film 102. For example, if the desired spatial resolution is x (the size in any direction of any rupture in the film which should be detected), in the configurations from FIGS. 1(a) and 1(b), the pattern dimension “d” is selected to be x/sqrt(2). In the case of system 130 of FIG. 1(c), the pattern dimension “d” can be selected as equal to x/3.

As a function of the desired film area to be monitored, any of the above configurations can be easily spatially extended by increasing the number of patterns (indicated by “n” in FIG. 1(b)) in the configuration. Additionally any of these electrically conductive traces can be an element of a printed electrically circuit as schematically illustrated, for example, in FIG. 2 with respect to the configuration of system 130 of FIG. 1(c). The conductive traces can be arranged in the circuit in such a manner so that a trace configuration forms one arm of a Wheatstone bridge circuit. In this manner, a very large printed distributed Wheatstone bridge circuit can be obtained. For maximum sensitivity of the Wheatstone bridge to any change in any of the resistance due to tampering, equal values can be implemented for the four distributed resistances forming the circuit bridge.

During a tampering event, a rupture may appear in the dielectric film 102, which also indicates the interruption of a conductive trace, thereby changing the electrical resistance of one arm of Wheatstone bridge circuit. The electronic module 203 that conditions and processes the signal from the distributed Wheatstone bridge circuit can detect the event and wireless transmit data concerning the event through the antenna 210, 212 to the real time monitoring station 304, which is connected to networked services (e.g., the “Internet”). The novelty of using a large area distributed Wheatstone bridge as a self-monitoring circuit for a 2D structural integrity sensor eliminates the use of a single resistor with a resistor value below 500 kohm, as described in the prior art.

There are several advantages to using a large area distributed Wheatstone bridge. For example, as the differential voltage signal offered by the Wheatstone bridge is measured, one can increase the resistance range of the value of a constituent distributed resistor to large values of approximately hundreds of mega ohms. The only limitation is that the output impedance of the Wheatstone bridge may be ten fold times lower than the input impedance of an instrumentation amplifier (IA) used for the signal conditioning from Wheatstone bridge. This input impedance of IA in prior art devices is even higher than 1 Gohm.

Additionally, using four large area distributed resistances of equal value and configured from the same material and technology results in the aging process influencing in the same manner all the resistances and the differential operation of the Wheatstone bridge. This makes the aging essentially “invisible” to the IA. Thus, a robust solution is disclosed for tampering detection, which is insensitive to aging/drift phenomena in the conductive traces.

Using four large area distributed resistances of equal value and made from the same material and technology also permits the temperature variation in the ambient (increase or decrease) to influence in the same manner all the resistances and the differential operation of Wheatstone bridge. This in turn also makes the temperature effect essentially “invisible” to the IA. Thus, by using the large area Wheatstone bridge, a robust solution for tampering detection can be provide with a temperature compensation capability.

On very large area films, an array of such distributed sensors (printed electrically circuits+electronic module) can be deployed. The array 300 of sensing systems depicted in FIG. 3 represents an example of such an array. Such an array 300 of sensing systems can be wirelessly monitored by an individual monitoring and transmitter unit 302, which can also be wirelessly linked to the central station 304. Very large area films with printed distributed circuits can be used for wrapping very large pallets or containers, realizing in this manner their structural integrity and anti-theft monitoring during transportation and storage.

Additionally, such arrays of distributed sensors can be implemented in the context of a very large area “smart carpet”, as schematically depicted by an ultra large array of sensing systems 400 of FIG. 4. Such a “smart carpet” or ultra large array 400 can be formed from a very large area dielectric film 102 having distributed circuits that function as a sensor for monitoring their mechanical integrity. Such an ultra large array 400 can also be utilized for wirelessly monitoring the structural integrity of tents, truck's cover, or other large area surfaces in the assets monitoring field.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A wireless monitoring system, comprising:
a distributed electrical circuit printed on a dielectric film for wrapping pallets or containers in a logistic chain, wherein said distributed electrical circuit detects a rupture of said dielectric film through an electrical resistance change of at least one element of said distributed electrical circuit, wherein said electrical resistance change is indicative of a potential tampering event;
an electronic module that conditions and processes a signal transmitted from said distributed electrical circuit and thereafter transmits said signal wirelessly via an antenna to a monitoring station; and
a monitoring station that communicates with a network and said electronic module, which permits a user in real time to receive data concerning said potential tampering event associated said pallets or containers based on said electrical resistance change of said at least one element of said distributed electrically circuit, thereby permitting wireless monitoring of the integrity of said dielectric film and said pallets or containers in said logistic chain.

2. The system of claim 1 wherein said distributed electrical circuit comprises a printed electrical circuit having a large area distributed Wheatstone Bridge circuit comprising a plurality of bridge arms comprising printed electrically conductive traces.

3. The system of claim 2 wherein said electrical resistance comprises a distributed electrical resistance associated with said distributed electrical circuit, such that a value of said distributed electrical resistance is equal therebetween for a maximum sensitivity to a tampering event.

4. The system of claim 3 wherein said distributed electrical resistance comprises a maximum resistance value in a range of hundreds of mega-ohms and limited only by an input impedance of an instrumentation amplifier associated with said distributed electrical circuit, wherein said instrumentation amplifier comprises a resistance value in a range of giga-ohms.

5. The system of claim 2 wherein said printed electrically conductive traces comprise two printed layers separated by an isolator.

6. The system of claim 2 wherein said printed electrically conductive traces comprise two printed layers, wherein each of said two printed layers are located on different dielectric foils associated with said dielectric film.

7. The system of claim 2 wherein said printed electrically conductive traces comprise two printed layers printed on either side of said dielectric film.

8. The system of claim 1 wherein said dielectric film comprises plastic.

9. The system of claim 8 further comprising a smart carpet formed from said dielectric film, wherein said dielectric film comprises a very large area dielectric film incorporating said distributed electrical circuit, wherein said distributed electrical circuit comprises a sensor for monitoring a mechanical integrity of an asset.

10. The system of claim 1 wherein said network comprises a computer network.

11. A wireless monitoring system, comprising:
a large area distributed electrical circuit printed on a dielectric film for wrapping pallets or containers in a logistic chain, wherein said distributed electrical circuit detects a rupture of said dielectric film through an electrical resistance change of at least one element of said distributed electrical circuit, wherein said electrical resistance change is indicative of a potential tampering event;
an electronic module that conditions and processes a signal transmitted from said distributed electrical circuit and thereafter transmits said signal wirelessly via an antenna to a monitoring station; and
a monitoring station that communicates with a network and said electronic module, which permits a user in real time to receive data concerning said potential tampering event associated said pallets or containers based on said electrical resistance change of said at least one element of said distributed electrically circuit, thereby permitting wireless monitoring of the integrity of said dielectric film and said pallets or containers in said logistic chain, wherein said distributed electrical circuit comprises a printed electrical circuit having a Wheatstone Bridge circuit comprising a plurality of bridge arms comprising printed electrically conductive traces, such that said electrical resistance comprises a distributed electrical resistance associated with said distributed electrical circuit, such that a value of said distributed electrical resistance is equal therebetween for a maximum sensitivity to a tampering event.

12. A wireless monitoring method, comprising:
printing a large area distributed electrical circuit on a dielectric film for wrapping pallets or containers in a logistic chain, wherein said distributed electrical circuit detects a rupture of said dielectric film through an electrical resistance change of at least one element of said distributed electrical circuit, wherein said electrical resistance change is indicative of a potential tampering event;
providing an electronic module that conditions and processes a signal transmitted from said distributed electrical circuit and thereafter transmits said signal wirelessly via an antenna to a monitoring station; and
providing a monitoring station that communicates with a network and said electronic module, which permits a user in real time to receive data concerning said potential tampering event associated said pallets or containers based on said electrical resistance change of said at least one element of said distributed electrically circuit, thereby permitting wireless monitoring of the integrity of said dielectric film and said pallets or containers in said logistic chain.

13. The method of claim 12 wherein said distributed electrical circuit comprises a printed electrical circuit having a Wheatstone Bridge circuit comprising a plurality of bridge arms comprising printed electrically conductive traces.

14. The method of claim 3 wherein said electrical resistance comprises a distributed electrical resistance associated with said distributed electrical circuit, such that a value of said distributed electrical resistance is equal therebetween for a maximum sensitivity to a tampering event.

15. The method of claim 14 wherein said distributed electrical resistance comprises a maximum resistance value in a range of hundreds of mega-ohms and limited only by an input impedance of an instrumentation amplifier associated with said distributed electrical circuit, wherein said instrumentation amplifier comprises an input impedance value in a range of giga-ohms.

16. The method of claim 13 wherein said printed electrically conductive traces comprise two printed layers separated by an isolator.

17. The method of claim 13 wherein said printed electrically conductive traces comprise two printed layers, wherein each of said two printed layers are located on different foils associated with said dielectric film.

18. The method of claim 13 wherein said printed electrically conductive traces comprise two printed layers printed on either side of said dielectric film.

19. The method of claim 12 wherein said dielectric film comprises dielectric plastic.

20. The method of claim 8 further comprising a smart carpet formed from said dielectric film, wherein said dielectric film comprises a very large area film incorporating said large area distributed electrical circuit, wherein said distributed electrical circuit comprises a sensor for monitoring a mechanical integrity of an asset.
